(19) United States
(12) Patent Application Publication
(10) Pub. No.: US 2018/0122368 A1
(43) Pub. Date: May 3, 2018

(54) MULTIPARTY CONVERSATION ASSISTANCE IN MOBILE DEVICES

(71) Applicant: INTERNATIONAL BUSINESS MACHINES CORPORATION, Armonk, NY (US)

(72) Inventors: Sean R. COSTELLO, St. Leonards (AU); Stefan HARRER, Melbourne (AU); Laurence J. PLANT, Melbourne (AU)

(21) Appl. No.: 15/342,850

(22) Filed: Nov. 3, 2016

(51) Int. Cl. G10L 15/18; H04M 3/56; H04M 1/247; G06N 3/063; G06F 3/0481; G10L 17/02; G10L 21/0208; G10L 21/0316; G10L 25/63

(52) U.S. Cl. CPC G10L 15/1815; H04M 3/56; H04M 1/247; G06N 3/0635; G10L 25/63; G10L 17/02; G10L 21/0208; G10L 21/0316; G06F 3/04817

(57) ABSTRACT

A method, computer program product, and system for providing assistance during a multiparty communication include a processor(s) receiving, over a communications network data from a multiparty communication involving two or more participants, wherein the data comprises audio data. Among the processor(s) is a neuromorphic processor. The neuromorphic processor analyzes the data based on recognizing pre-defined speech patterns in the audio data and produces analytics based on the analysis of the data, during the multiparty communication, based on recognizing pre-defined speech patterns in the audio data. The processor(s) determines at least one sentiment of a first participant of the two or more participants participating in the multiparty communication. The processor(s) generates a visual representation of the multiparty communication that includes a representation of the at least one sentiment. The processor(s) displays the visual representation in a graphical user interface of the device that includes the neuromorphic processor.

### BACKGROUND

When participating in a remote communication method, including telephone calls, conference calls, video conferences, and web lecture, with one or more additional parties, a participant can only rely on his or her perception of the audio to understand the sentiment of the other party or parties on the line. This information can be limited. For example, a participant could speculate that a given speaker is agitated, concerned, or distracted, based on vocal cues, but these speaker sentiments and mental states may not be clear or correct. A participant could accidentally misperceive the sentiment or mental state of another participant because they do not have a close personal relationship, so one participant does not know the other well enough to correctly ascertain the other's sentiment and/or mental state. One participant could mistake the sentiment of another if the two do not share the same cultural background as the meaning of certain behaviors can differ based on cultural norms. Also, some individuals are better than others at perceiving the emotions of others; some people do not have empathy and/or are easily distracted. This additional information can be beneficial; while during a conversation a participant understands that another expressed agreement with hesitation, this sentiment can be lost when the first participant cannot see the second participant.

### SUMMARY

Shortcomings of the prior art are overcome and additional advantages are provided through the provision of a method for providing real time guidance during a multiparty communication. The method includes, for instance: receiving, over a communications network, by one or more processors, the one or more processors comprising a neuromorphic processor, communication data during a multiparty communication involving two or more participants, wherein the communication data comprises audio data; analyzing, by the neuromorphic processor, the communication data based on recognizing pre-defined speech patterns in the audio data; producing, by the neuromorphic processor, analytics based on the analysis of the communication data; based on the analytics, determining, by the one or more processors, at least one sentiment of a first participant of the two or more participants participating in the multiparty communication; generating, by the one or more processor, based on the at least one sentiment of the first participant, a visual representation of the multiparty communication comprising a representation of the at least one sentiment for the first participant; and displaying, by the one or more processors, during the multiparty communication, the visual representation in a graphical user interface of a device, wherein the device comprises the neuromorphic processor.

Methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts elements of a technical architecture into which aspects of an embodiments of the present invention are implemented;

FIG. 2 depicts certain aspects of an embodiment of the present invention;

FIG. 3 depicts certain aspects of an embodiment of the present invention;

FIG. 4 is a workflow illustrating certain aspects of an embodiment of the present invention;

FIG. 5 is a workflow illustrating certain aspects of an embodiment of the present invention;

FIG. 6 depicts one embodiment of a computing node that can be utilized in a cloud computing environment;

FIG. 7 depicts a cloud computing environment according to an embodiment of the present invention; and

FIG. 8 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

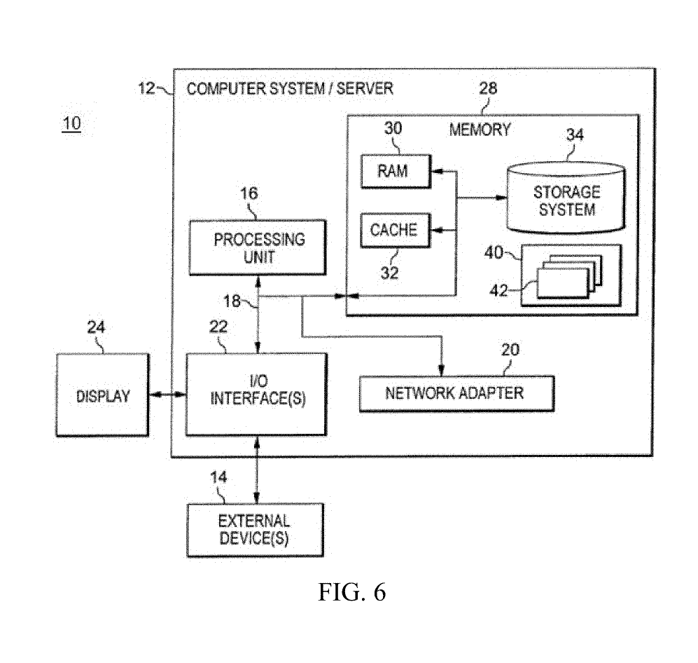

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 6 as program/utility 40, having a set (at least one) of program modules 42, may be stored in memory 28.

Participating in multiparty communications where the participants are remote from each of other is prevalent in both business and personal communications. A common refrain is that although these multiparty communication, including but not limited to, telephone calls, conference calls, video conferences, and/or web lectures, may provide financial and convenience benefits, the range of the interactions of the participants with each other is narrowed by the media. In the best case scenario, the participants can hear each other, but this audio does not reveal the full range of perceivable information that is garnered in an in-person interaction. Among the problems, which are all addressed by aspects of embodiments of the present invention, are the absence of an understanding of the mental state and sentiments of listeners during a communication, and the inability to modulate the volume of each participants so that the conversation is more reflective of how the participants would speak in an in-person interaction.

Understanding the mental state or sentiment of an individual engages in a multiparty communication can be difficult for the other participants involved in the communication. However, having access to this information would enhance the ability of the participants to communicate with each other and understand more about the experience of the individual on the communication. For example, as discussed above, it can be very difficult to divine the mental state or sentiment of an individual on a multiparty communication based only on the perceptible audio. For example, an individual may be agitated, concerned, and/or distracted, but these speaker sentiments and mental states may not be clear to the other participant(s). When participant(s) on a multiparty communication with an individual can comprehend the sentiments and/or mental state of the individual, the participant(s) can utilize the communication opportunity more effectively. Understanding the sentiments of the individual could provide data to the participant that would enable the participant to guide the conversation in an effective direction.

Just as analyzing a listener, like the individual above, can help other participants, who are speaking, modify their rhetoric to communicate most effectively with the individual, analyzing the participants themselves, when they are speaking, can also potentially improved the communication as a whole. In general, some speakers are more engaging than others because their tone shows enthusiasm, while others are less engaging because they speak in monotone. A speaker may not be aware of his or her vocal foibles, such as a monotone, that detract from the efficacy of his or her message. If a speaker were able to understand (in real-time, meaning contemporaneous with the communication, i.e., during the communication) when he or she is speaking in a way that is less effective, the speaker could then correct his or her speech to address this issue and, as a result, arguably resonate more effectively with the remaining individuals on the communication.

Another challenge on a multiparty communication in managing the audio levels of the various participants. Each speaker is in a different location with different background noise, different acoustic properties, different quality telephone devices, and different quality network connections. As a result, certain speakers can be heard and understood more easily than others. Current technology only enables the listener to adjust the volume of the communication, rather than to adjust selectively the volume for individual speakers.

Aspects of certain embodiments of the present invention provide improvements to multiparty communications by providing: 1) conversation strategy guidance to selected participants (listeners) by making recommendations to a speaker to re-engage the listener(s); 2) real time sentimental analysis of speaker to improve engagement or performance of the speaker; and/or 3) adjustments for the volume for individual speakers/participants, selectively.

As described below, in embodiments of the present invention, one or more programs receives data from a multiparty communication, during the course of the communication. The one or more programs analyze the data, produce analytics, determine the sentiments of one or more participants based on the analytics, generate a visual representation of the sentiments, and display the sentiments, during the course of the communication. Thus, a participant can effectively receive this feedback in real time, i.e., at a time when the communication is still in session, so that he or she can react to this information in order to positively impact the communication. For example, if a participant receives information during a presentation that is given during a multiparty communication that a number of the participants are not engaged with the presentation, the participant giving the presentation can adjust his or her approach. As the participant makes adjustments, he or she is able to utilize an embodiment of the present invention to learn, while the communication is still ongoing, if these adjustments are impacting the engagement of the formerly unengaged participants. If this information were available to the participant giving the presentation only after the communication had ended, it would be far less useful because the participant would have no opportunity to make any contemporaneous changes.

For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define, are well understood by those skilled in the art.

In an embodiment of the present invention, program code, which may comprise software executing on at least one processing circuit, and/or firmware executing on an integrated circuit provides benefits in multiparty communication that are inextricably tied to computing and represents an improvement to previous multiparty communication technologies. For example, the program code provides conference participants with real-time insights into the emotional state of other participants in the form of generating real-time conversation strategies that provide participants with guidance as to how direct the conversation in a mutually beneficial direction. In an embodiment of the present invention, the program code moderates the discussion in a multiparty communication by providing an independently operating virtual conversation/negotiation coach. The coaching functionality of the program code, in an embodiment of the present invention, provides the same service to all participants of a call in a democratic fashion. The program code, in an embodiment of the present invention, performs housekeeping actions to improve the quality and experience of the communication for the participants. These actions include, but are not limited to, filtering out background noise, toning up a speaker's contribution when appropriate, and filtering out offline discussions from the main stream of conversation.

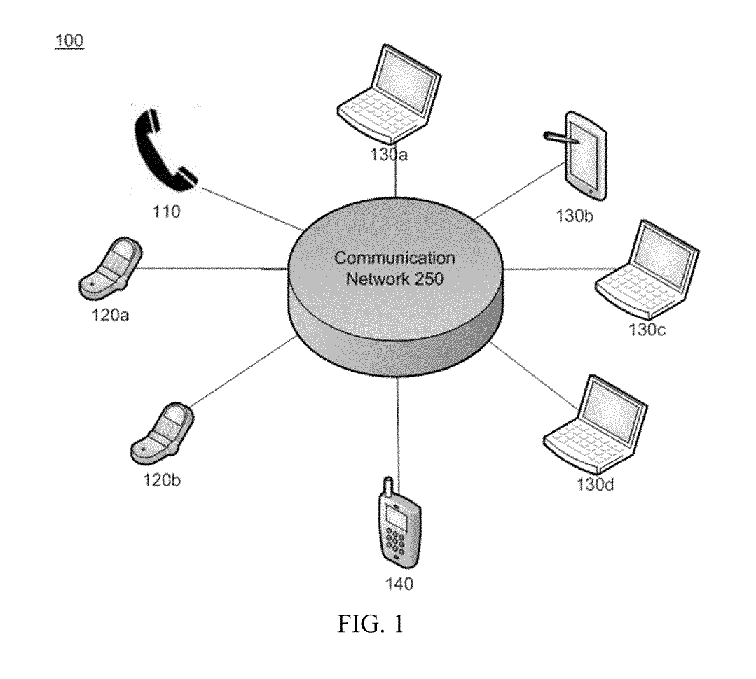

FIG. 1 is a technical environment 100 into which aspects of an embodiment of the present invention can be integrated. In the technical environment 100, a number of calling devices can be utilized with which to participate in a multiparty communication. Technical environments that employ different aspects of the present invention can utilize varying communication devices. As an example, in FIG. 1, the devices utilized to connect to a multiparty communication include a phone 110 that connects to the communication utilizing a landline (a wire connection), two cellular phones 120a-120b, four mobile computing devices 130a-d, and a smartphone 140. The devices other than the phone 110 connect to a communication network 150 via a wireless connection. The phone 110 connects to this network 150 with a wired connection. The smartphone 140 includes at least one processing circuit that can execute program code that is either stored on an internal memory in the smartphone 140 or is accessible the one or more processing circuit through the communications network 150.

In an embodiment of the present invention, one or more of the devices that connect to a communications network 150 for a multiparty communication, execute program code to provide real-time speech and optionally facial expression recognition capabilities, the latter of which are available in an embodiment of the present invention where the multiparty communication offers a video channel on top of the audio channel, utilized by the participants over the communications network 150 to participate in the communication. As an example, in the technical environment 100 of FIG. 1, the smartphone 140 includes this capability. As explained above, the program code provides the speech and optionally facial recognition capabilities when the communication is still ongoing, such that a participant in the communication, and/or one or more programs can take actions based on these capabilities.

In an embodiment of the present invention, to connect to the multiparty communication, a program(s) assigns each participant a personalized account, which specifies call-in information for use in connecting to the communication. The program(s) may distribute this information to the individual participants via email or another electronic notification method over the communication network 150.

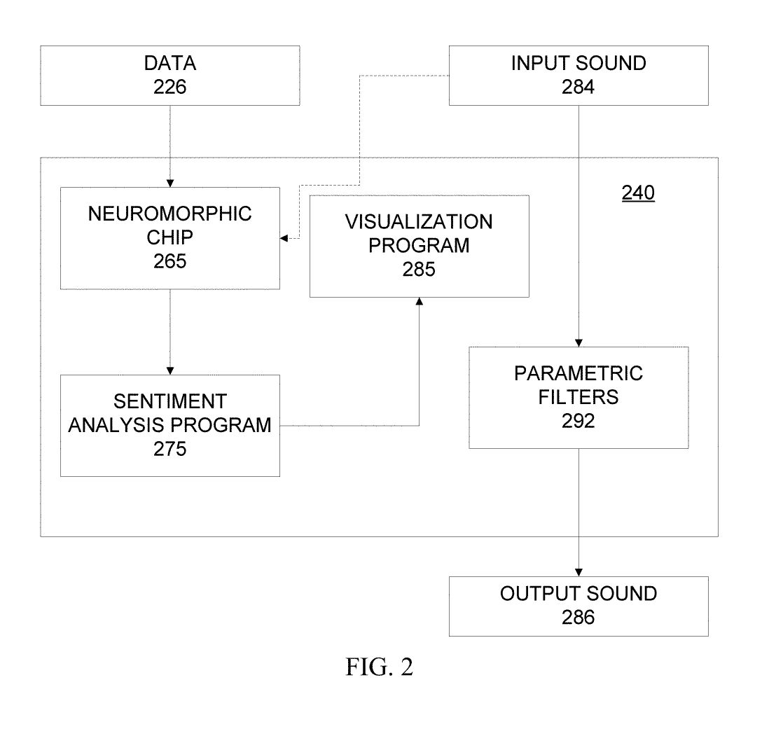

FIG. 2 is an illustration of a device 240, in this example the smartphone 140 of FIG. 1. Functionality representing aspects of an embodiment of the present invention integrated into the device 240 is depicted in this figure as modules, for ease of understanding. As understood by one of skill in the art, the functionalities described herein may comprise one or more programs executed by one or more processing resources of the device 240. The one or more programs, which provide analytics, may be executed by a trained neuromorphic chip 265, specifically, or a neuromorphic processor, generally. The neuromorphic processor or trained neuromorphic chip 265 can be incorporated into the device 240, as seen in FIG. 2, or it can be associated with the device 240, via a network connection.

One example of a trained neuromorphic chip 265 that is utilized in an embodiment of the present invention is the IBM® TrueNorth chip, produced by International Business Machines Corporation. IBM is a registered trademark of International Business Machines Corporation, Armonk, N.Y., U.S.A. Other names used herein may be registered trademarks, trademarks or product names of International Business Machines Corporation or other companies.

The IBM TrueNorth chip, also referred to as TrueNorth, is a neuromorphic complementary metal-oxide-semiconductor (CMOS) chip. TrueNorth includes a manycore network on a chip design (e.g., 4096 cores), each one simulating programmable silicon “neurons” (e.g., 256 programs) for a total of just over a million neurons. In turn, each neuron has 256 programmable synapses that convey the signals between them. Hence, the total number of programmable synapses is just over 268 million (2̂28). Memory, computation, and communication are handled in each of the 4096 neurosynaptic cores, so TrueNorth circumvents the von-Neumann-architecture bottlenecks and is very energy-efficient.

In an embodiment of the present invention, the neuromorphic chip 265 or processor, incorporated or associated with the device 240, receives audio and/or video data 226 and provides pattern analysis of the audio and/or video data received by the device during the multiparty communication, producing analytics. A sentiment analysis program(s) 275 executing on a processing resource of the device 240 utilize the analytics to determine the sentiment of each speaker in a multiparty communications session. Once the sentiment analysis program(s) 275 has determined the sentiments of each speaker of the communication, a visualization program(s) 285, executed by a processing resource of the device 240, such as the neuromorphic processor, generates a graphical representation of the sentiments and displays the representation of a graphical user interface (GUI) of the device 240.

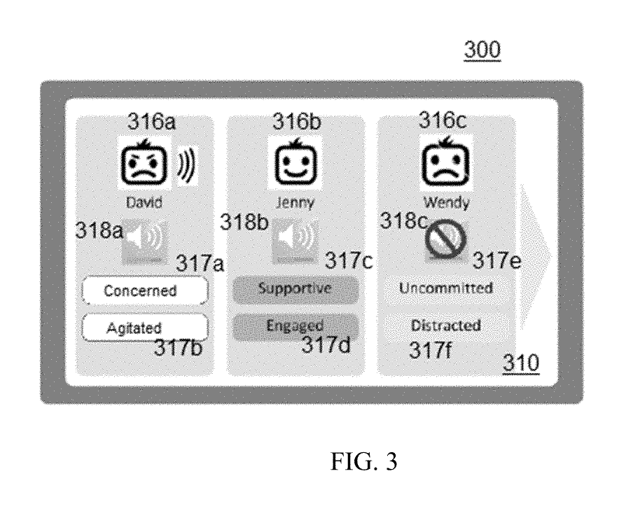

In an embodiment of the present invention, the visualization of the multiparty communications session, generated by the visualization program(s) 285, may include s representation of each participant's sentiment. FIG. 3 is an example of a visualization 300 of user sentiments that is generated by the visualization program(s) 285 in an embodiment of the present invention. In an embodiment of the present invention, the visualization 300, which is displayed by the visualization program(s) 285 (FIG. 2) as a GUI of a display 310 of the device 240 (FIG. 2), provides information regarding the mental state and the sentiment of the participants in a multiparty communication. Depending upon the embodiment of the present invention, the sentiments and mental state of each user may be selectively available to certain other users. For example, in an embodiment of the present invention, only the leader (initiator) of a multiparty communication may be able to view a visualization 300.

Referring to FIG. 3, in an embodiment of the present invention, the visualization 300 includes information from both real-time speech and facial expression recognition capabilities, based on the multiparty communication including a video channel on top of the audio channel. As seen in this example, the program code visualized three participants who are involved in a multiparty communication, David, Jenny, and Wendy. For each participant, the visualization program 285 (FIG. 2) generated, based on the analytics generated by the trained neuromorphic chip 265 (FIG. 2) or a neuromorphic processor, which were analyzed by a sentiment analysis program 275, and provided to the visualization program 285 (FIG. 2), an icon 316a-316c representing the facial expression of the individual and whether that individual is speaking at a given time, as well as words 317a-317f words representing the sentiments of the participants. As discussed earlier, embodiments of the present invention provide individual volume control of the various participants. Thus, the visualization program 285 (FIG. 2) displays a volume state 318a-318c for each participant, which the program code can adjust. In an embodiment of the present invention, a user can interact with the volume settings through the visualization 300, which is displayed on a touch screen.

Returning to FIG. 2, the programs executing of the device 240 to perform aspects of an embodiment of the present invention may also include one or more parametric filters 292. As stated earlier, current technology only enables the listener to only adjust the call volume, current technology does not enable a listener to selectively adjust the volume for individual speakers. However, in an embodiment of the present invention, the parametric filters 292 receive sound (input) 284 from the speaker, including the environmental noise, and selectively enhance the volume or just the range of frequencies of a speaker's voice and filter or suppress extraneous noise, such as hums, electronic feedback, construction sounds, etc., to produce an enhanced sound output 286.

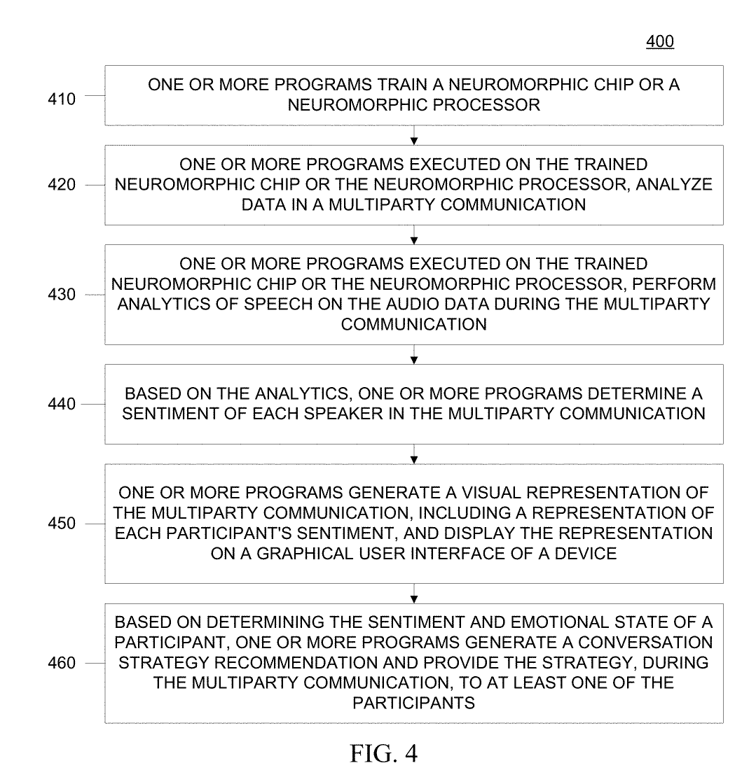

FIG. 4 is a workflow 400 of an embodiment of the present invention that illustrates certain aspects of the embodiment. As aforementioned, in an embodiment of the present invention, one or more programs executed on a trained neuromorphic chip 265 (FIG. 2) or a neuromorphic processor(s), generate analytics, based on the audio, and optionally, video data, obtained from participants on a multiparty communication. As seen in FIG. 4, in an embodiment of the present invention, to enable to the neuromorphic chip or processor to provide the analytics, one or more programs train the neuromorphic chip or processor (410). The one or more programs train the neuromorphic chip or program(s) executed by the neuromorphic processor utilizing machine learning and/or deep learning technology to recognize the participants' sentiments through speech (and if applicable, facial expression) analysis and to contextualize the detected sentiments with the content of the conversation on the multiparty communication. For example, the one or more programs may train the Such can for example be achieved by training the neuromorphic chip or program(s) executed by the neuromorphic processor to contextualize specific sentiments with conversation parameters, including but not limited to, keywords, key phrases, conversation tone, and/or specific conversation phases (e.g., greeting, negotiation, complaint handling, closing the call). The training program(s) utilize test and/or training sample communications to train this cognitive analytics platform (i.e., the neuromorphic chip or processor). As will be discussed further in reference to FIG. 4, once the cognitive analytics platform is trained, tested, and in operation, the programs executing on one or more processing resources provide conference participants with real-time insights into the emotional state of other participants, meaning that these insights are provided by the programs while the communication is in session, within a timeframe that enables a participant and/or a program to make an adjustment based on the insights. One or more programs use that information to provide participants with guidance as to how direct the conversation in a mutually beneficial direction, by generating conversation strategies within a window where utilizing the strategies could potentially affect the communication.

Returning to FIG. 4, in an embodiment of the present invention, one or more programs executed on the trained neuromorphic chip 265 (FIG. 2) or neuromorphic processor, embedded in or associated with a listener's device, analyze the audio (and optionally, video) in a multiparty communication (420). In an embodiment of the present invention, one or more programs executed on the trained neuromorphic chip 265 (FIG. 2) or neuromorphic processor perform analytics of speech on the audio during the multiparty communication (430). Based on the analytics, one or more programs determines a sentiment of each speaker in the multiparty communications (440). The program code may also determine an emotional state of each participant based on the analytics. It is beneficial for parties in a conference call to understand the sentiment of other parties in the call. For example, a speaker may state that he or she agrees, but the listener would benefit from understanding the speaker appears reluctant or stressed or distracted.

In an embodiment of the present invention, one or more programs generate a visual representation of the multiparty communication, including a representation of each participant's sentiment, and displays the representation of the device (450). The programs can continuously collect and analyze audio (and, optionally, video) in the multiparty communication and ultimately provide updates to the visualization in real time. By continuously monitoring participant sentiment and mental state, the program code can visualize key events or moments in the conversation, when the sentiments of one or more of the participants changes, For example, one or more participants could lose or gain agreement on a core idea. Detection of these key moments is allows a facilitator to appreciate the moments, for example, alerting the facilitator that he or she is about to close a sales proposal, or conversely, that a potential customer is losing confidence or agreement.

In an embodiment of the present invention, based on determining the sentiment and emotional state of a participant, one or more programs generates a conversation strategy recommendation (e.g., tone, content, timing) and provides the strategy, during the multiparty communication, to at least one of the participants (460). For example, the program could notify a user that a given participant is distracted and provide the user with recommendations on how to re-engage the participant. The system could be configured to provide these recommendations to all users or to only certain users, for example, this functionality could be selectively available moderator/negotiator support system (i.e., a negotiator uses the system). The program could provide a user with observations regarding the state of the remaining participants from the audio analysis, as well as recommendations on how to guide the participants through the conversation, in a proactive way.

One application of the recommendation aspect of an embodiment of the present invention is in a call center, where a speaker could utilize the guidance and analysis of a caller's sentiments and mental state to de-escalate a complaint. For example, the program code could display the agitation of a customer on an agitation scale, going from a maximum level to a minimum level. Depending on which state the program(s) determined that the customer is presenting, based on analyzing the speech of the customer, the program selects a de-escalation strategies, including recommending that the speaker remain passive (e.g., “just listen, don't talk back”) or utilize a more proactive approach (e.g., “explain problem, propose remediation offer now”).

Another scenario where the recommendation aspect of an embodiment of the present invention would be beneficial is in distance learning. For example, the program code could guide a teacher by providing the teacher with information regarding the level of engagement of individual students. One or more programs would present the teacher with recommended courses of interaction to stimulate engagement and improve learning outcomes.

In an embodiment of the present invention, the program code provides recommendations based on analyzing the speech of a speaker, enabling the speaker to adjust his or her tone, content, timing, etc., to garner a more engaged audience. By applying real time analysis of speaker utterances and feedback to the speaker, the speaker is given guidance on how to improve his or her speech in order to improve engagement. For example, the program code can alert the speaker to the fact that the speaker's tone is too soft, or fast, or that the speaker is using too many acronyms and losing the audience. In an embodiment of the present invention, one or more programs (e.g., parametric filters) may assist the speaker by automatically enhancing the volume or just the range of frequencies of the speaker's voice, and filter or suppress extraneous noise, such as hums, electronic feedback, construction sounds, etc.

In an embodiment of the present invention, the program code moderates discussion on the multiparty communication by providing a virtual conversation/negotiation coach. The coaching service can be provided to one or more participants on a multiparty communication and can provide housekeeping actions (e.g., filtering out background noise, toning up a speaker's contribution when appropriate, filtering out offline discussions from the main stream of conversation).

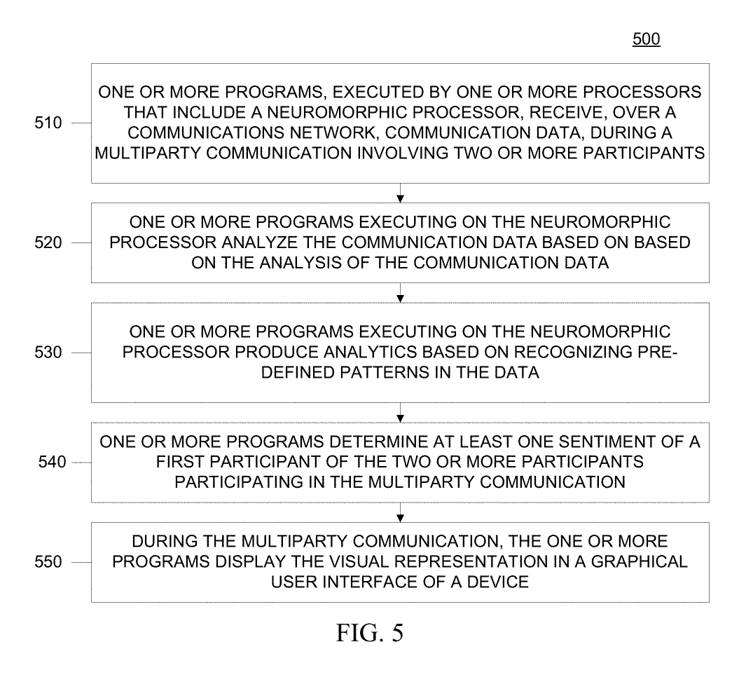

FIG. 5 is a workflow 500 of an embodiment of the present invention that illustrates certain aspects of the embodiment. In this embodiment, one or more programs, executed by one or more processors that include a neuromorphic processor, receive, over a communications network, communication data, during a multiparty communication involving two or more participants (510). This data may comprise one or more of audio data and/or video data. One or more programs executing on the neuromorphic processor analyze the communication data based on recognizing pre-defined speech patterns in the audio data (520). One or more programs executing on the neuromorphic processor produce analytics based on the analysis of the communication data (530). For example, the one or more programs may recognize pre-defined speech patterns in the audio data and/or predefined facial expression-related patterns in the video data.

In an embodiment of the present invention, one or more programs determine at least one sentiment of a first participant of the two or more participants participating in the multiparty communication (540). The one or more programs generate, based on the at least one sentiment of the first participant, a visual representation of the multiparty communication comprising a representation of the at least one sentiment for the first participant. During the multiparty communication, the one or more programs display the visual representation in a graphical user interface of a device (550). In an embodiment of the present invention, the device includes the neuromorphic processor.

Referring now to FIG. 6, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the device 240 (FIG. 2) utilized by a participant on a multiparty communication can be understood as cloud computing node 10 (FIG. 6) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

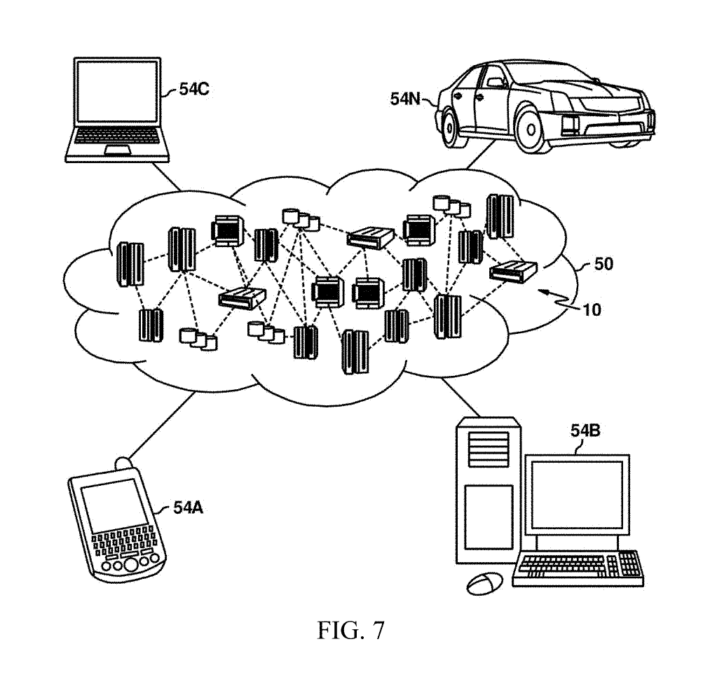

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

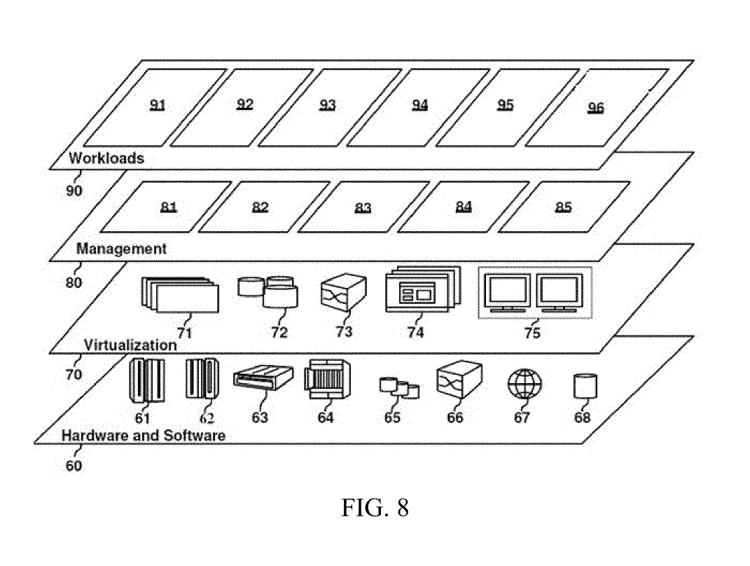

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and analyzing contemporaneous data to determine a responsive action 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
receiving, over a communications network, by one or more processors, the one or more processors comprising a neuromorphic processor, communication data during a multiparty communication involving two or more participants, wherein the communication data comprises audio data;
analyzing, by the neuromorphic processor, the communication data based on recognizing pre-defined speech patterns in the audio data;
producing, by the neuromorphic processor, analytics based on the analysis of the communication data;
based on the analytics, determining, by the one or more processors, at least one sentiment of a first participant of the two or more participants participating in the multiparty communication;
generating, by the one or more processor, based on the at least one sentiment of the first participant, a visual representation of the multiparty communication comprising a representation of the at least one sentiment for the first participant; and
displaying, by the one or more processors, during the multiparty communication, the visual representation in a graphical user interface of a device, wherein the device comprises the neuromorphic processor.

2. The computer-implemented method of claim 1, wherein a user of the device is the first participant.

3. The computer-implemented of claim 1, further comprising:
based on the analytics, determining, by the one or more processors, at least one sentiment of a second participant of the two or more participants participating in the multiparty communication;
updating, by the one or more processor, the visual representation, based on the at least one sentiment of the second participant, to include a representation of the at least one sentiment for the second participant; and
displaying, by the one or more processors, during the multiparty communication, the updated visual representation in the graphical user interface of the device.

4. The computer-implemented method of claim 1, wherein the multiparty communication is selected from the group consisting of: a telephone call, a conference call, a video conference, and a web lecture.

5. The computer-implemented method of claim 1, further comprising:
based on determining the at least one sentiment of the first participant, generating a conversation strategy recommendation.

6. The computer-implemented method of claim 5, further comprising providing, by the one or more processors, during the multiparty communication, the conversation strategy to a second participant of the two or more participants, by displaying the conversation strategy in the graphical user interface.

7. The computer-implemented method of claim 5, further comprising:
automatically adjusting, by the one or more processors, a setting on the device to enact the conversation strategy.

8. The computer-implemented method of claim 7, wherein the automatically adjusting comprises:
applying, by the one or more processors, a parametric filter to sound received by the device from the first participant, to selectively enhance the sound of the multiparty communication.

9. The computer-implemented method of claim 8, wherein the selectively enhancing comprises one or more of: adjusting the volume of the sound, adjusting the range of frequencies of a voice of the first participant, filtering out extraneous noise, and suppressing extraneous noise.

10. The computer-implemented method of claim 1, further comprising:
receiving, over the communications network, by the one or more processors, training data comprising audio communications; and
utilizing, by the one or more processors, a machine learning algorithm or a deep learning algorithm, and the training data, to generate the pre-defined speech patterns to train the neuromorphic processor to produce the analytics.

11. The computer-implemented method of claim 1, wherein the neuromorphic processor comprises a neuromorphic chip.

12. The computer-implemented method of claim 1, wherein the communication data further comprises video data; and the analyzing the communication data is further based on recognizing pre-facial expressions in the video data.

13. The computer-implemented method of claim 1, further comprising:
based on determining the at least one sentiment of the first participant, adjusting, by the one or more processors, a volume received at the device of audio from the first participant and maintaining a volume received at the device of audio from a second participant of the at least two participants.

14. A computer program product comprising:
a computer readable storage medium readable by one or more processors and storing instructions for execution by the one or more processors for performing a method comprising:
receiving, over a communications network, by the one or more processors, the one or more processors comprising a neuromorphic processor, communication data during a multiparty communication involving two or more participants, wherein the communication data comprises audio data;
analyzing, by the neuromorphic processor, the communication data based on recognizing pre-defined speech patterns in the audio data;
producing, by the neuromorphic processor, analytics based on the analysis of the communication data;
based on the analytics, determining, by the one or more processors, at least one sentiment of a first participant of the two or more participants participating in the multiparty communication;
generating, by the one or more processor, based on the at least one sentiment of the first participant, a visual representation of the multiparty communication comprising a representation of the at least one sentiment for the first participant; and
displaying, by the one or more processors, during the multiparty communication, the visual representation in a graphical user interface of a device, wherein the device comprises the neuromorphic processor.

15. The computer program product of claim 14, wherein a user of the device is the first participant.

16. The computer program product of claim 14, the method further comprising:
based on the analytics, determining, by the one or more processors, at least one sentiment of a second participant of the two or more participants participating in the multiparty communication;
updating, by the one or more processor, the visual representation, based on the at least one sentiment of the second participant, to include a representation of the at least one sentiment for the second participant; and
displaying, by the one or more processors, during the multiparty communication, the updated visual representation in the graphical user interface of the device.

17. The computer program product of claim 14, wherein the multiparty communication is selected from the group consisting of: a telephone call, a conference call, a video conference, and a web lecture.

18. The computer program product of claim 13, the method further comprising:
based on determining the at least one sentiment of each participant of the two or more participants, generating a conversation strategy recommendation; and
providing, by the one or more processors, during the multiparty communication, the conversation strategy to a second participant of the two or more participants, by displaying the conversation strategy in the graphical user interface; or
automatically adjusting, by the one or more processors, a setting on the device to enact the conversation strategy.

19. The computer program product of claim 16, the method further comprising
applying, by the one or more processors, a parametric filter to sound received by the device from the first participant, to selectively enhance the sound of the multiparty communication.

20. A system comprising:
a memory;
one or more processors in communication with the memory; and
program instructions executable by the one or more processors via the memory to perform a method, the method comprising:
receiving, over a communications network, by the one or more processors, the one or more processors comprising a neuromorphic processor, communication data during a multiparty communication involving two or more participants, wherein the communication data comprises audio data;
analyzing, by the neuromorphic processor, the communication data based on recognizing pre-defined speech patterns in the audio data;
producing, by the neuromorphic processor, analytics based on the analysis of the communication data;
based on the analytics, determining, by the one or more processors, at least one sentiment of a first participant of the two or more participants participating in the multiparty communication;
generating, by the one or more processor, based on the at least one sentiment of the first participant, a visual representation of the multiparty communication comprising a representation of the at least one sentiment for the first participant; and
displaying, by the one or more processors, during the multiparty communication, the visual representation in a graphical user interface of a device, wherein the device comprises the neuromorphic processor.
